(19) United States
(12) Patent Application Publication
(10) Pub. No.: US 2012/0052827 A1
(43) Pub. Date: Mar. 1, 2012

(54) DECISION DIRECTED ANTENNA DIVERSITY IN RADIO FREQUENCY RECEIVERS

(75) Inventors: Ahmed K. Sadek, San Diego, CA (US); Raamkumar Balamurthi, San Digeo, CA (US)

(73) Assignee: QUALCOMM Incorporated, San Diego, CA (US)

(21) Appl. No.: 13/215,490

(22) Filed: Aug. 23, 2011

Related U.S. Application Data
(60) Provisional application No. 61/377,198, filed on Aug. 26, 2010.

(51) Int. Cl. H04B 17/00

(52) U.S. Cl. 455/226.1

(57) ABSTRACT

A white space sensing method includes receiving a signal on each of multiple antennas in an alternating fashion. The method also includes calculating feature metrics for incumbent signals on a given frequency channel for all antennas (e.g., pilot strength, luminance carrier strength (for NTSC)). The strongest of the antennas can be selected, based on the calculated feature metrics, for white space sensing.

### CROSS REFERENCE TO RELATED APPLICATION

The present Application for Patent claims priority to U.S. Provisional Patent Application No. 61/377,198 entitled “Decision Directed Antenna Diversity in Radio Frequency Receivers” filed Aug. 26, 2010, assigned to the assignee hereof and expressly incorporated by reference herein in its entirety.

### TECHNICAL FIELD

The present disclosure relates, in general, to wireless communication systems, and, more particularly, to antenna diversity in radio frequency (RF) receivers.

### BACKGROUND

The Federal Communications Commission (FCC) is an independent agency of the United States government that is charged with regulating all non-federal government use of the radio spectrum (including radio and TV broadcasting), and all interstate telecommunications (wire, satellite and cable) as well as all international communications that originate or terminate in the United States. In 2010, the FCC finalized rules approving the unlicensed signal operation in the unused TV channels (i.e., white space). The new rules allow wireless technologies to use the TV white space as long as the technology and any resulting signal transmissions do not interfere with the existing primary users. For example, cognitive devices, such as white space devices, are allowed to use TV frequency bands if they do not cause harmful interference to TV receivers. Thus, cognitive radio demands a technology that can continuously sense the environment, dynamically identify unused spectral segments, and then operate in these white spaces without causing harmful interference to the incumbent users. Cognitive radio is a paradigm for wireless communication in which either a network or a wireless node changes its transmission or reception parameters to communicate efficiently avoiding interference with licensed or unlicensed users.

There are three types of primary signals: digital TV, which follows the ATSC format in North America; analog TV, which follows the NTSC format; and wireless microphones, which are narrowband (less than 200 kHz) signals with tunable operating frequency and typically use analog frequency modulation (FM). Other applicable signals include any applications that are entitled by regulations to use a specified portion of the spectrum. For purposes of this disclosure, the various devices that utilize such technologies to access this TV white space will be referred to as “white space devices,” “unlicensed devices,” “white space sensing devices,” or the like.

White space devices with spectrum sensing capability generally operate in a cognitive manner in which the devices first scan to detect TV band signals from licensed primary users. The white space devices will then select unused channels in order to avoid interference with the licensed signals. Therefore, these white space devices generally share two common functions: (1) sensing for incumbent signals; and (2) selecting appropriate channels for interference avoidance.

Sensing of narrowband signal features, however, is affected by fading, for example, Rayleigh fading. Rayleigh fading causes narrowband signals to fade as much as 20 dB or more, which makes them difficult to sense. In addition, the sensing performance improves slowly with increasing signal-to-noise ratio (SNR) in a Rayleigh fading channel, unlike the situation in a non-fading channel where sensing performance improves much quicker with increasing SNR.

Some previous sensing techniques have utilized only a single sensing antenna. These techniques sense ATSC or wireless microphones with a single sensing antenna. These known sensing techniques require estimation of the power spectrum over a portion of the channel bandwidth and, hence, suffer from the effects of fading. Accordingly, it would be desirable to perform spectrum sensing of narrowband features in a wireless channel with less susceptibility to fading in order to increase sensing performance.

### SUMMARY

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

According to some aspect of the disclosure, a white space sensing method includes receiving a signal on each of multiple antennas in an alternating fashion. The method may also include calculating feature metrics for incumbent signals on a given frequency channel for all antennas. Further, the method may include selecting the strongest of the antennas, based on the calculated feature metrics, for white space sensing.

In some aspects of the disclosure, an apparatus for wireless communication in white space includes a means for receiving a signal on each of multiple antennas in an alternating fashion and a means for calculating feature metrics for incumbent signals on a given frequency channel for all antennas. The apparatus also includes a means for selecting the strongest of the antennas, based on the calculated feature metrics, for white space sensing.

According to some aspects of the disclosure, a computer program product for wireless communication in white space includes a computer-readable medium having a program code recorded thereon. The program code includes program code to receive a signal on each of multiple antennas in an alternating fashion and to calculate feature metrics for incumbent signals on a given frequency channel for all antennas. The program code also includes program code to select the strongest of the antennas, based on the calculated feature metrics, for white space sensing.

In some aspects of the disclosure, an apparatus for wireless communication in white space includes a memory and at least one processor coupled to the memory. The at least one processor is configured to receive a signal on each of multiple antennas in an alternating fashion and to calculate feature metrics for incumbent signals on a given frequency channel for all antennas. The processor(s) is also configured to select the strongest of the antennas, based on the calculated feature metrics, for white space sensing.

### BRIEF DESCRIPTION OF THE DRAWINGS

For a more complete understanding of the present teachings, reference is now made to the following description taken in conjunction with the accompanying drawings.

FIG. 1 is a block diagram illustrating an exemplary white space network in which an embodiment of the disclosure may be advantageously employed.

FIG. 2 illustrates an exemplary wireless device that may be used in the system of FIG. 1.

FIG. 3A illustrates a block diagram of an antenna sensing system based on a single antenna sensing process.

FIG. 3B illustrates a block diagram of an antenna sensing system based on a dual antenna switching sensing process.

FIG. 4 illustrates a block diagram of a multiple antenna sensing system based on a decision directed antenna selection process.

FIG. 5 illustrates a method of wireless communication in white space according to an embodiment of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

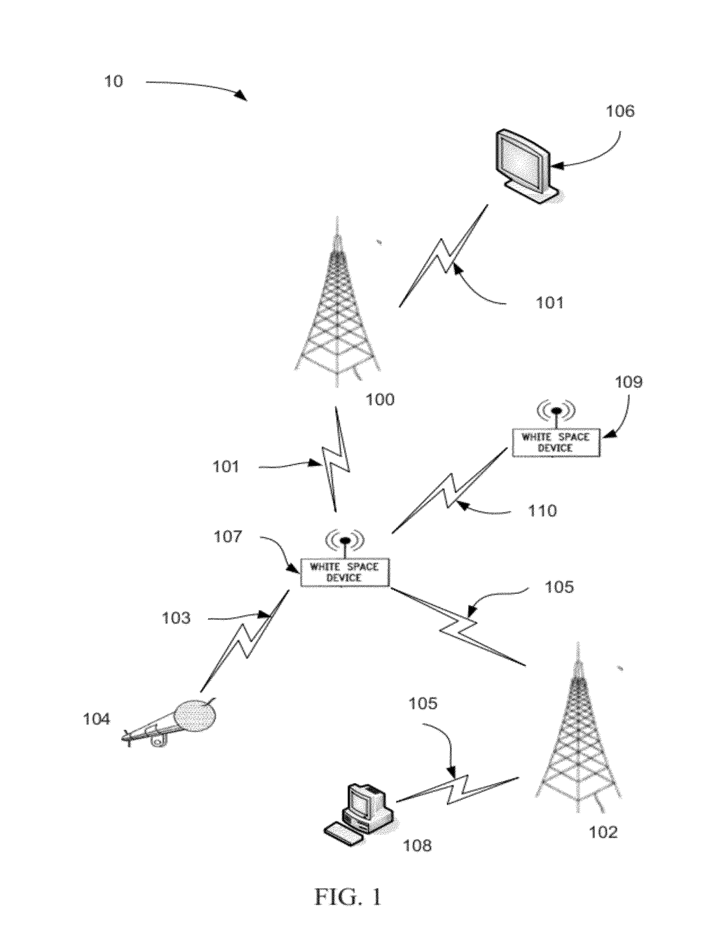

Referring to FIG. 1, a block diagram is shown conceptually illustrating a, white space network 10 configured according to one embodiment of the present teachings. The white space network 10 may be a television white space network that includes certain television channel frequencies for use by certain wireless microphone systems. The white space network may include licensed ATSC signals 101 and licensed NTSC signals 105 that originate from primary users, such as TV broadcasters and the like. The TV white space network may also include a wireless microphone signal 103 generated by a wireless microphone 104, for example. The ATSC signal 101 and the NTSC signal 105 may be generated from an ATSC transmitter 100 and a NTSC transmitter 102, respectively. Many different devices 106 and 108, such as a TV tuner, a computer and the like, may use such licensed ATSC and NTSC signals 101 and 105. Each of the ATSC signals 101, the NTSC signals 105 and the wireless microphone signals 103 are licensed signals protected from interference by FCC regulations of various white space devices 107 or 109. In order to operate such white space devices 107 or 109 in the presence of licensed ATSC signals 101, NTSC signals 105 and wireless microphone signals 103, embodiments of the present disclosure provide for white space devices 107 or 109 to monitor the white space signals, such that white space devices 107 or 109 may distinguish between primary signals such as licensed ATSC signals 101, NTSC signals 105, wireless microphone signals 103, and secondary white space signals.

In some embodiments, the white space device 107 or 109 may be a device, such as devices 106 and 108, configured for white space sensing. For example, a white space device can be a laptop computer equipped with an ATSC or NTSC signal detector and internal wireless antenna, which configure the laptop computer for wirelessly transmitting and receiving white space signals. The user of a white space device 107, such as a laptop computer may have developed content that he or she intends to share over the TV white space network 10 with other white space devices, ATSC or NTSC devices, such as device 109. The white space device 107 begins by sensing the available spectrum in its vicinity, for example. It detects the ATSC, wireless microphone or NTSC signal 101, 103 or 105 and identifies these channel as off-limits for any unlicensed transmissions. The white space device 107 then generates a secondary white space signal 110 for other white space devices, ATSC or NTSC devices, such as device 109, using a white space channel that is currently unused by any licensed transmissions.

It should be noted that any variety of information may be communicated between white space devices 107 and 109 individually or participating in a white space network 10. Examples of such information include sensing information, such as channel availability, location information, signal strength information, white space pilot frequency information, offset information, and the like. Moreover, cooperative sensing may be enabled through sharing of resources between different white space devices 107 and 109 within the white space network 10. For example, with reference to FIG. 1, the white space device 109 may not have the capability to determine location. By leveraging the white space network 10, the white space device 109 may query the other white space devices 107 for such location information. In response, the white space device 107 may transmit such location information to the white space device 109. As such, the white space device 109 may benefit from information obtained from devices having additional capabilities.

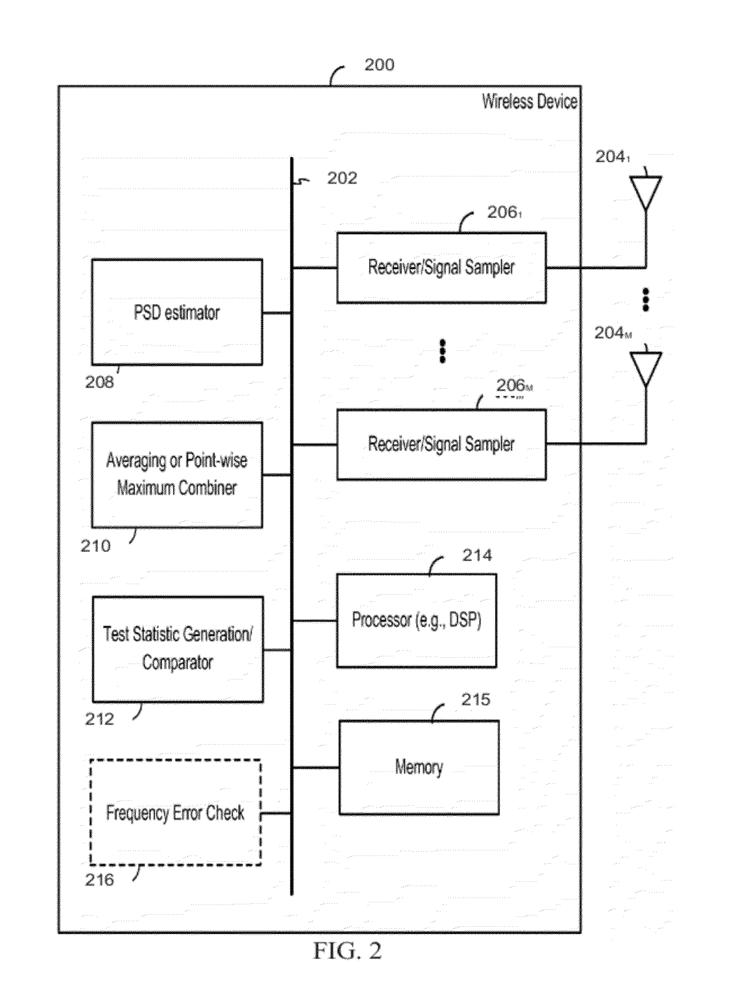

FIG. 2 illustrates an exemplary wireless device that may be used in the system of FIG. 1. It is noted that device 200 may be a receiver portion of a wireless device, which could be a user device 106, 108 or 109 in FIG. 1, a receiver portion of transmitters or base stations 100 and 102, or even simply a testing device (not shown herein). The device 200 includes a number of various functional modules for spectrum sensing of narrowband features (e.g., ATSC, NTSC, wireless microphones, or other licensed wireless transmissions) using spatial diversity. The various modules are shown communicatively coupled with a central data bus 202, or similar device for communicatively linking the several modules together.

The user device 200 includes multiple antennas 204₁-204_{M} with corresponding RF receiver circuitry and digital sampling circuitry 206₁-206_{M} to provide samples of the signal received by the respective antennas 204. The digital samples are communicated via the bus 202 to a PSD generator or estimator 208, which is configured to generate PSDs for each antenna.

The device 200 also includes an averaging or point-wise maximum combiner 210 configured to combine the PSDs determined by the generator 208 according to the methods disclosed previously. The combined PSD resulting from the combiner 210 is then used by a test statistic generator 212 to compute a test statistic according to either the maximum PSD, or a normalized strongest PSD component.

The generator 212 may also be configured to compare the generated test statistic to the predetermined threshold and thereby make the determination whether the narrowband signal features (e.g., a pilot signal) are present or not. Alternatively, the device 200 may include at least one processor 214 (e.g., a DSP) to perform any of the calculations or comparisons effected by any of blocks 208, 210, and 212. A memory 215 or other storage medium may associate with the processor 214 to store instructions or code executable by the processor. Additionally, an optional frequency error check unit 216 may be employed to perform an additional frequency check.

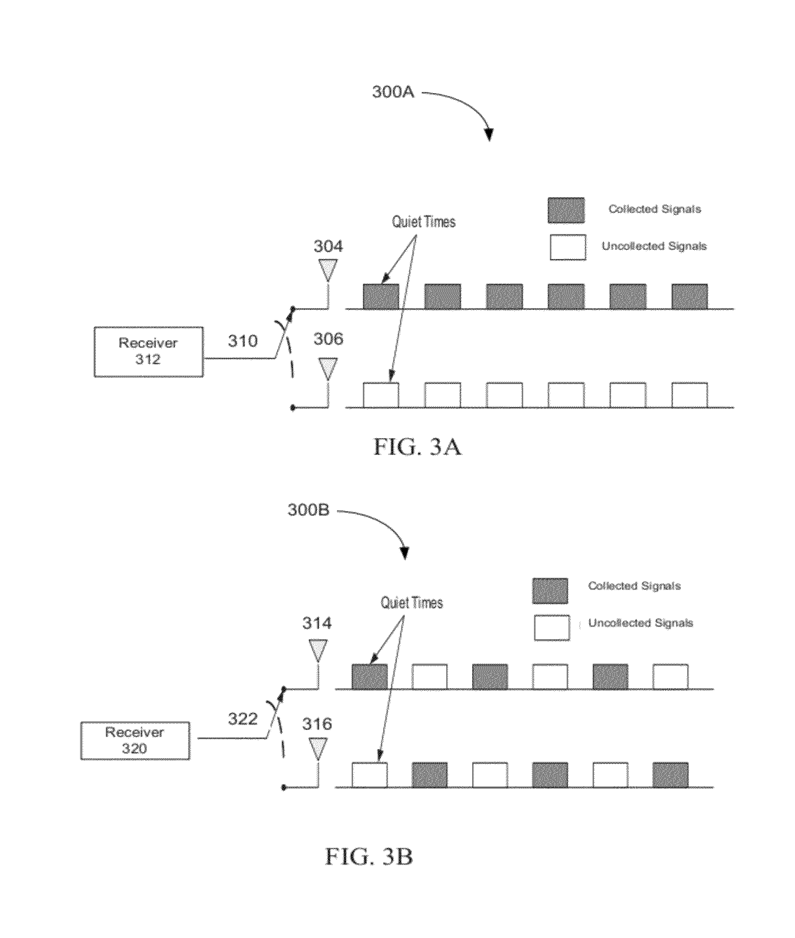

FIG. 3A illustrates a block diagram of an antenna sensing system based on a single antenna sensing process. In particular, FIG. 3A, illustrates a system 300A, which incorporates a conventional sensing process that does not utilize antenna diversity. Antenna diversity or spatial diversity may be one of several diversity schemes that use two or more antennas 304 and 306, for example, to improve the quality and reliability of wireless communication.

In order to reliably detect incumbent signals, at a very low SNR, the wireless device 200 configured for white space sensing, listens to the medium for a relatively long time in order to capture and analyze the received signals. The long dwelling time achieves processing gain to increase the SNR of the signals. The wireless device 200 is quiet (i.e., stops transmitting) during this signal collection phase to avoid any leakage from the transmitted signal to the collected signals. The time used by the wireless device 200 to collect signals may be denoted as quiet time. In order to reduce the impact of quiet time on system latency, the total quiet time is divided into disjoint smaller quiet times or quiet time signals.

In FIG. 3A, all signals sensed during quiet time are collected from the same antenna 304 according to a single antenna sensing process. Accordingly, no antenna or spatial diversity is achieved and the system suffers from unreliable performance in fading environments. In particular, if the antenna 304 experienced a deep fade then a mis-detection could occur even if the incumbent signal was above the −114 dBm FCC sensing threshold. This sensing process employs a single antenna 304 to receive the signals sensed during quiet times while other signals during quiet times are not used or collected. A switch 310 can be configured to couple the antenna 304 to a receiver 312 in order to bypass the second antenna 306.

FIG. 3B illustrates a block diagram of prior art of an antenna sensing system 300B based on a dual antenna switching sensing process. The antenna switching process incorporated in the system 300B achieves spatial or antenna diversity because the signals sensed during quiet times are collected in an alternating fashion between two antennas 314 and 316. Hence, there is a low probability that both antennas 314 and 316 will be faded at the same time. Non-coherent combining of the signals collected at different quiet times is performed since no phase or synchronization information is available at a sensor, for example, associated with the wireless device 200. A decision metric is based on jointly considering all the signals sensed during quiet times.

Because there is a probability that one of the two antennas 314 and 316 may experience fading, half of the signals sensed during quiet times may be collected from a faded antenna. This implementation may result in a signal to noise ratio (SNR) loss compared to an ideal case when all the signals sensed during quiet times are collected from the unfaded antenna.

In some embodiments, each antenna 314 and 316 may be coupled to a separate receiver. However, a single receiver 320 can also be implemented for multiple antennas 314 and 316. If a single receiver 320 is used, the process may rely on a switching device 322, for switching between two or more antennas, as described in U.S. patent application Ser. No. 12/618,533 to Shellhammer, filed Nov. 13, 2009, the disclosure of which is expressly incorporated by reference herein in its entirety.

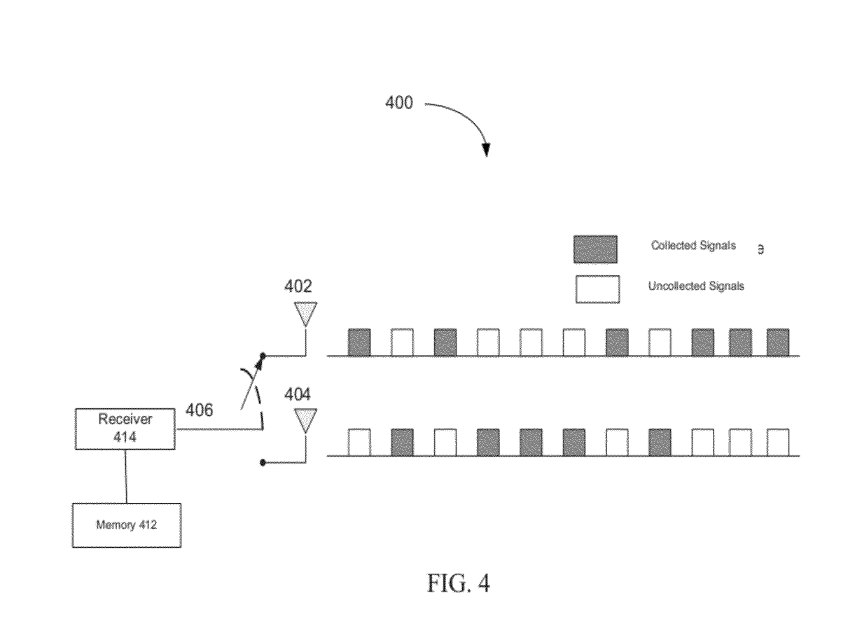

FIG. 4 illustrates a block diagram of a multiple antenna sensing system 400 based on a decision directed antenna selection process. The multiple antenna system 400 receives signals that are sensed during quiet times at multiple antennas 402 and 404. The multiple antenna system 400 may be implemented with multiple receivers or a single receiver 414. The system 400, achieves spatial or antenna diversity because the signals sensed during quiet times are collected in an alternating fashion between the two antennas 402 and 404. In some embodiments, the signals sensed during quiet times may be collected based on non-alternating implementations.

Because the information about fading realization at each antenna 402 and 404, for example, is not known a priori, a learning phase is performed first. In this learning phase, the first few signals sensed during quiet times are alternatively collected between the two antennas 402 and 404. From these few sensed signals, the strength of the incumbent signal features can be calculated for both antennas 402 and 404. Based on this information, the antenna that has the stronger feature can be identified. The rest of the signals sensed during quiet times can be collected from the stronger antenna. This implementation avoids the SNR loss incurred by collecting signals from the weaker antenna. In one embodiment, this learning phase is repeated periodically at some predetermined rate, which could be specified by a channel coherence time or the process requirements.

In some embodiments, the multiple antenna sensing system 400 may be implemented according to the following process: A decision directed antenna selection process can be implemented such that the collection of signals sensed during quiet times are alternated between the two antennas 402 and 404 for the first N signals sensed during quiet times. N may be a predetermined number that is selected such that an adequate number of signals sensed during quiet times are received in order to determine the antenna with better incumbent signal features. The incumbent signal feature from the collected signals sensed during quiet times can be calculated for both antennas 402 and 404. The metric for the first and second antennas 402 and 404 may be denoted as Metric1 and Metric2, respectively. In the event that more than one incumbent signal type (for example ATSC, NTSC) is received at the antennas 402 and 404, features for all the incumbent signal types can be calculated and the strongest feature for each antenna 402 and 404 is saved, in memory 412, for example. The antenna that has the highest metric may be selected and the next M signals sensed during quiet times are collected from the selected antenna. M may be a predetermined number that is selected such that an adequate number of signals sensed during quiet times are received with the system requirements, for example. The following implementation can be repeated as more signals sensed during quiet times are received. The process repeats the learning phase based on system requirements and/or channel coherence time and fading characteristics.

Antenna selection is based on the incumbent signal feature. In some embodiments, the metrics may be calculated based on numerous different feature types for selecting a strong antenna. Some of the features include one or more of the following: detection of pilot strength, luminance carrier strength, signal energy, and carrier strength, energy detection, cyclostationary feature detection, pseudorandom noise (PN) sequence correlation, signal bandwidth, signal height, area under the curve of a signal, Lp norm of a signal, and generalized average of the signal strength. The feature metrics may also include a variation of one or more of the following features: pilot signal strength, luminance carrier strength, signal energy, cyclostationary features, pseudorandom noise (PN) sequence correlation, signal bandwidth, signal height, area under the curve of a signal, Lp norm of a signal, and generalized average of the signal strength. Consider a vector X of length N defined as X=[x1, x2, x3, . . . , xN]. The Lp norm for the vector X is defined as

$${Lp ( X ) = {x}_{1}^{p} + {x}_{2}^{p} + {x}_{3}^{p} + … + {x}_{N}^{p} )}^{\frac{1}{p}}$$

where p and v are real numbers.

The features can also be based on a correlation of a pseudorandom noise (PN) sequence in an ATSC signal by a matching filter. In some aspects, virtually any feature of TV whitespace sensing may be used as a basis for selecting an antenna according to illustrative embodiments of the present disclosure. The antenna having the strongest calculated metric for a given feature may be selected. The feature may be continuously or periodically monitored on each antenna to enable switching between selected antennas as the features change over time.

A switch 406, for example, can be configured to couple the antenna 404 or 402 to the one or more receivers 414. In some embodiments, the decision directed antenna selection process may be implemented at the antennas 402 and/or 404, the receiver 414, a controller (not shown) associated with the wireless device 200 or a combination thereof.

Embodiments of the present disclosure may select a strongest antenna based on other features such as FM narrowband signals used in wireless microphone applications, for example. Features of an FM narrowband signal that may be considered as metrics for selecting a strongest antenna include bandwidth of the narrowband signals, height of the narrowband signal, area under the curve of a narrowband signal, Lp norm of the narrowband signal or a generalized average of the narrowband signal strength.

The features described in the present disclosure for selecting a strongest antenna may be described more generally as spectral features. These features are subject to temporal variation. The temporal variation of a spectral feature may also be used as a basis for selecting a strongest antenna according to an illustrative embodiment of the present disclosure. For example, the temporal variation of bandwidth in an FM narrowband signal may be computed for a number of antennae. Periodic switching may be performed to select the antenna having a strongest bandwidth variation.

The process incorporated in the system 400 improves the performance of a spectrum sensing systems. In some embodiments, the system 400 achieves higher SNR gain while achieving the same spatial diversity gain as the antenna switching scheme. In particular, the white space sensing process based on decision directed antenna selection achieves higher SNR gain compared to known processes, which translates to a higher detection probability of incumbent signals.

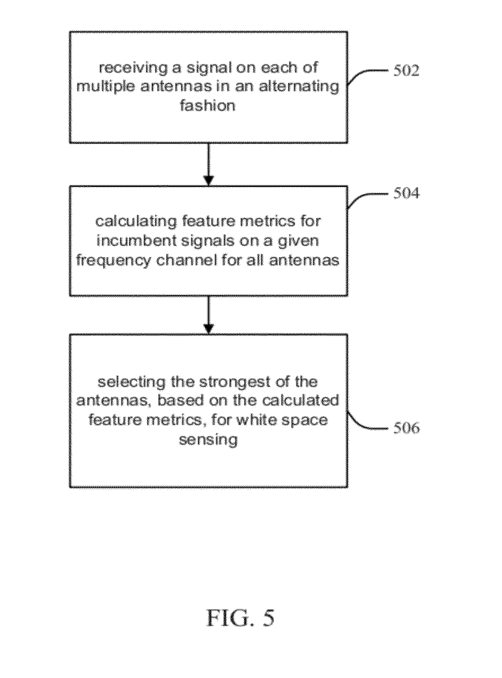

FIG. 5 illustrates a method of wireless communication in white space according to an embodiment of the disclosure. At block 502, the method includes receiving a signal on each of multiple antennas in an alternating fashion. At block 504, the method includes calculating feature metrics for incumbent signals on a given frequency channel for all antennas. At block 506, the method includes selecting the strongest of the antennas, based on the calculated feature metrics, for white space sensing.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine or computer readable medium tangibly embodying instructions may be used in implementing the methodologies described herein. For example, software code may be stored in a memory and executed by a processor. When executed by the processor, the executing software code generates the operational environment that implements the various methodologies and functionalities of the different aspects of the teachings presented herein. Memory may be implemented within the processor or external to the processor. As used herein, the term “memory” refers to any type of long term, short term, volatile, nonvolatile, or other memory and is not to be limited to any particular type of memory or number of memories, or type of media upon which memory is stored.

The machine or computer readable medium that stores the software code defining the methodologies and functions described herein includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. As used herein, disk and/or disc includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present teachings and their advantages have been described in detail, it should be understood that various changes, substitutions and alterations can be made herein without departing from the technology of the teachings as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present teachings. Accordingly, the appended claims are intended to include within their scope such processes, machines, manufacture, compositions of matter, means, methods, or steps.

What is claimed is:

1. A white space sensing method, comprising:
receiving a signal on each of a plurality of antennas in an alternating fashion;
calculating feature metrics for incumbent signals on a given frequency channel for all antennas; and
selecting the strongest of the antennas, based on the calculated feature metrics, for white space sensing.

2. The method of claim 1, further comprising:
comparing feature metrics for different incumbent signals;
tracking a signal with the strongest feature metric for a predetermined period; and
identifying an antenna from which the strongest feature metric is received.

3. The method of claim 1, further comprising repeating the receiving, calculating, and selecting after a predetermined period has elapsed.

4. The method of claim 3, in which the predetermined period is based on one of system requirements and channel conditions, the system requirements comprising one of delay and throughput requirements, the channel conditions comprising fading characteristics.

5. The method of claim 1, in which the feature metrics comprise at least one of pilot signal strength, luminance carrier strength, signal energy, cyclostationary features, pseudorandom noise (PN) sequence correlation, signal bandwidth, signal height, area under a curve of a signal, Lp norm of a signal, and generalized average of the signal strength.

6. The method of claim 1, in which the feature metrics comprise a variation in at least one of pilot signal strength, luminance carrier strength, signal energy, cyclostationary features, pseudorandom noise (PN) sequence correlation, signal bandwidth, signal height, area under a curve of a signal, Lp norm of a signal, and generalized average of the signal strength.

7. An apparatus for wireless communication in white space, comprising:
means for receiving a signal on each of a plurality of antennas in an alternating fashion;
means for calculating feature metrics for incumbent signals on a given frequency channel for all antennas; and
means for selecting the strongest of the antennas, based on the calculated feature metrics, for white space sensing.

8. The apparatus of claim 7, further comprising:
means for comparing feature metrics for different incumbent signals;
means for tracking a signal with the strongest feature metric for a predetermined period; and
means for identifying an antenna from which the strongest feature metric is received.

9. The apparatus of claim 7, further comprising means for repeating the receiving, calculating, and selecting after a predetermined period has elapsed.

10. The method of claim 9, in which the predetermined period is based on at least one of system requirements and channel conditions, the system requirements comprising one of delay and throughput requirements, the channel conditions comprising fading characteristics.

11. A computer program product for wireless communication in white space, comprising:
a computer-readable medium having non-transitory program code recorded thereon, the program code comprising:
program code to receive a signal on each of a plurality of antennas in an alternating fashion;
program code to calculate feature metrics for incumbent signals on a given frequency channel for all antennas; and
program code to select the strongest of the antennas, based on the calculated feature metrics, for white space sensing.

12. The computer program product of claim 11, further comprising:
program code to compare feature metrics for different incumbent signals;
program code to track a signal with the strongest feature metric for a predetermined period; and
program code to identify an antenna from which the strongest feature metric is received.

13. The computer program product of claim 11, further comprising program code to repeat the receiving, calculating, and selecting after a predetermined period has elapsed.

14. The computer program product of claim 13, in which the predetermined period is based on at least one of system requirements and channel conditions, the system requirements comprising one of delay and throughput requirements, the channel conditions comprising fading characteristics.

15. An apparatus for wireless communication in white space, comprising:
a memory; and
at least one processor coupled to the memory, the at least one processor being configured:
to receive a signal on each of a plurality of antennas in an alternating fashion;
to calculate feature metrics for incumbent signals on a given frequency channel for all antennas; and
to select the strongest of the antennas, based on the calculated feature metrics, for white space sensing.

16. The apparatus of claim 15, in which the processor is further configured:
to compare feature metrics for different incumbent signals;
to track a signal with the strongest feature metric for a predetermined period; and
to identify an antenna from which the strongest feature metric is received.

17. The apparatus of claim 15, in which the processor is further configured to repeat the receiving, calculating, and selecting after a predetermined period has elapsed.

18. The apparatus of claim 17, in which the predetermined period is based on at least one of system requirements and channel conditions, the system requirements comprising one of delay and throughput requirements, the channel conditions comprising fading characteristics.

19. The apparatus of claim 15, in which the feature metrics comprise at least one of pilot signal strength, luminance carrier strength, signal energy, cyclostationary features, pseudorandom noise (PN) sequence correlation, signal bandwidth, signal height, area under a curve of a signal, Lp norm of a signal, and generalized average of the signal strength.

20. The apparatus of claim 15, in which the feature metrics comprise a variation in at least one of pilot signal strength, luminance carrier strength, signal energy, cyclostationary features, pseudorandom noise (PN) sequence correlation, signal bandwidth, signal height, area under a curve of a signal, Lp norm of a signal, and generalized average of the signal strength.
